(19) United States
(12) Patent Application Publication
(10) Pub. No.: US 2014/0113120 A1
(43) Pub. Date: Apr. 24, 2014

(54) ANTI-COLOR BANDING TOPCOAT FOR COATED ARTICLES

(71) Applicant: PPG INDUSTRIES OHIO, INC., Cleveland, OH (US)

(72) Inventor: James P. Thiel, Pittsburgh, PA (US)

(73) Assignee: PPG INDUSTRIES OHIO, INC., Cleveland, OH (US)

(21) Appl. No.: 13/655,685

(22) Filed: Oct. 19, 2012

(51) Int. Cl. B32B 7/02; B32B 9/04; B32B 18/00; B32B 15/04

(52) U.S. Cl. 428/212; 428/469; 428/448; 428/446

(57) ABSTRACT

A coated article includes a functional coating, e.g. an electroconductive low emissivity coating over a surface of a glass substrate and a chemical and/or mechanical protective coating, e.g. a coating of oxides of silicon and aluminum over the functional coating. The protective coating exhibits color banding when viewed under a light source having spectrally narrow emissions, e.g. a fluorescent lamp or light emitting diode, and adjacent ones of the color banding of the protective coating have a Delta E of greater than 5. An anti-banding coating layer of the invention is applied over the protective layer, wherein the anti-banding coating layer exhibits a Delta E of less than 3.

### BACKGROUND OF THE INVENTION

1. Field of the Invention

This invention relates to an anti-color banding topcoat for coated articles, and more particularly, the invention relates to a coated article having a transparent substrate, a functional coating, e.g. an infrared reflecting and/or electrically conductive coating, over a surface of the substrate; a protective coating over the functional coating, and an anti-banding coating layer over the protective coating, and the invention further relates to a method of making the coated article.

2. Discussion of the Present Technology

As is appreciated by those skilled in the coating art, sputtered vapor deposited coatings are not as durable as pyrolytically deposited coating, and the usual practice is to provide a protective sheet and/or a protective coating over the outer surface of the functional coating, e.g. as disclosed in U.S. Pat. No. 7,335,421. The protective sheet is usually a glass sheet laminated to the coated sheet. Although this method of protecting the coating is acceptable there are limitations. More particularly, the added cost of the protective glass sheet and the plastic layer to laminate the protective glass sheet to the surface of the coating, and the additional weight of the glass sheet and the plastic layer, make the use of protective sheets unacceptable. The limitations associated with using a glass sheet to protect the coating is minimized, if not eliminated by applying a protective coating layer over the outer surface of the functional coating, e.g. but not limited to the discussion presented in U.S. Pat. Nos. 6,916,542 and 7,335,421. The disclosure of U.S. Pat. Nos. 6,916,542 and 7,335,421 in their entirety are hereby incorporated by reference.

Although the use of the protective coating layer eliminates the drawbacks associated with the use of a protective sheet to protect the coating, there are limitations to the use of a protective coating layer. More particularly, it is noted that coated articles having the protective coating as the external surface of the coated article often exhibit excessive color banding, especially when the coated glass is viewed under lights having spectrally narrow emissions such as florescent lights and light emitting diodes, also known as LEDs. The term “banding” or “color banding” as used herein, is an effect that occurs when the color depth is insufficient to accurately sample a continuous gradation of color tone. As a result, a continuous gradient appears as a series of discrete steps or bands of color.

It can be appreciated, that coated transparent substrates, for example but not limited to residential and commercial monolithic windows, and monolithic vehicle side windows and rear windows, that exhibit banding under lighting having spectrally narrow emissions, e.g. fluorescent lighting of the type used in a show room is noticeable and aesthetically unacceptable. Therefore, eliminating banding caused by a protective layer over a functional coating without using the techniques presently available is desirable.

### SUMMARY OF THE INVENTION

This invention relates to a coated article having, among other things, a substrate having a major surface; a coating over the major surface of the substrate, wherein the coating exhibits color banding when viewed under a light source having spectrally narrow emissions, and adjacent ones of the color banding of the coating have a first measured Delta E, and an anti-banding coating layer over the chemical and/or mechanical protective layer, wherein the anti-banding coating layer exhibits color banding when viewed under the light source having spectrally narrow emissions, and adjacent ones of the color banding of the anti-banding coating layer have a second measured Delta E that is less than the first measured Delta E.

In one non-limiting embodiment of the invention the coating is a functional coating over the major surface of the substrate, and includes, among other things, a chemical and/or mechanical protective coating over the functional coating, wherein the chemical and/or mechanical protective coating exhibits color banding when viewed under the light source having spectrally narrow emissions, and adjacent ones of the color banding of the chemical and/or mechanical protective coating have the first measured Delta E.

### DESCRIPTION OF THE DRAWINGS

FIG. 1 is a cross-sectional view (not to scale) of a coated article having one non-limiting embodiment of the anti-banding coating layer of the invention.

FIG. 2 is a graph showing a* and b* color co-ordinance (CIELAB color system) of a prior art coated article viewed at different angles under an F-7 florescent light (Series 1 curve) and viewed under a broad band fight, e.g. a D-65 light source (Series 2 curve).

FIG. 3 is a view similar to the view of FIG. 1 of a coated article having another nonlimiting embodiment of the anti-banding coating layer of the invention.

FIG. 4 is a view similar to the view of FIG. 1 of a coated article having another non-limiting embodiment of the anti-banding coating layer of the invention.

FIG. 5 is a view similar to the view of FIG. 1 of a coated article having another non-limiting embodiment of the anti-banding coating layer of the invention.

FIG. 6 is a graph showing a* and b* color co-ordinance (CIELAB color system) of a coated article having a non-limiting embodiment of an anti-banding coating of the invention and viewed at different angles under an F-7 florescent light (Series 3 curve) and viewed under a broad band light, e.g. a D-65 light source (Series 4 curve). The coated article without the anti-banding coating of the invention has the a* and b* color co-ordinance (CIELAB color system) shown in FIG. 2.

### DETAILED DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims can vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Further, as used herein, the term “over”, means formed, applied, deposited, or provided on but not necessarily in contact with the surface. For example, a coating layer formed or applied “over” a substrate surface does not preclude the presence of one or more other coating layers or films of the same or different composition located between the formed coating layer and the surface of the substrate.

For purposes of clarity, an ultraviolet wavelength is a wavelength in the range of 300 nanometers (“nm”) to 380 nm; a visible wavelength is a wavelength in the range of greater than 380 nm to 800 nm; an infrared wavelength is a wavelength in the range of greater than 800 nm to 100,000 nm; of the electromagnetic spectrum. Additionally, all documents, such as but not limited to issued patents and patent applications, referred to herein are to be considered to be “incorporated by reference” in their entirety. The “ultraviolet transmission”, “visible transmission” and “infrared transmission” values are those determined using conventional methods. Those skilled in the art will understand that properties such as ultraviolet, visible and infrared transmissions can be calculated at an equivalent standard thickness, e.g., 2.1 millimeters (“mm”), even though the actual thickness of a measured glass sample is different than the standard thickness.

For purposes of the following discussion, the invention will be discussed with reference to a coated article such as, but not limited to a coated transparency. As will be appreciated, the invention is not limited to any particular use, or any particular type, of a coated article or coated transparency, and the coated article or coated transparency of the invention can be used in the manufacturing of, but not limited to, a vehicle transparency, such as but not limited to windshields, windows, rear lights, sunroofs and moonroofs; laminated or non-laminated residential and/or commercial windows; insulating glass units, and/or transparencies for land, air, space, on water and under water vehicles. Additionally, while a typical “transparency” can have sufficient visible light transmission such that materials can be viewed through the transparency, in the practice of the invention the “transparency” need not be transparent to visible light but can be translucent or opaque (as described below). Non-limiting examples of vehicle transparencies, residential and commercial transparencies, and aircraft transparencies and methods of making the same are found in U.S. Pat. Nos. 4,820,902; 5,028,759, 5,653,903, 5,301,858, and 7,335,421.

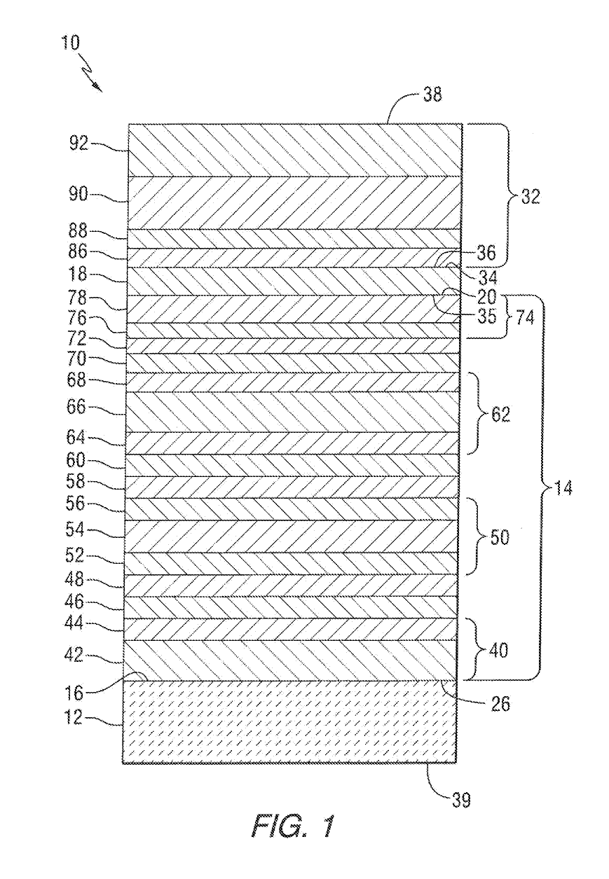

A non-limiting coated article or transparency 10 incorporating features of the invention is illustrated in FIG. 1. The transparency 10 can have any desired ultraviolet radiation transmission, visible light transmission, or infrared radiation, and reflection. For example, the transparency 10 can have a visible light transmission of any desired amount, e.g., but not limited to 0% or greater than 0% to 100%, more preferably 50% to 95% and most preferably 70%-95%.

As best seen in FIG. 1, the transparency 10 of the invention includes a transparent substrate 12 having a functional coating 14 applied on or over surface 16 of the substrate 12; a protective coating or layer 18 on or over surface 20 of the functional coating 14 and an anti-banding coating layer 32 on or over surface 34 of the protective coating layer 18. With the coating arrangement shown in FIG. 1, surface 26 of the functional coating 14 is opposite to the surface 20 of the functional coating 14 and is on or over the surface 16 of the substrate 12; surface 35 of the protective coating layer 18 is opposite to the surface 34 of the protective layer 18 and is on or over the surface 20 of the functional coating 18; a surface 36 of the anti-banding coating layer 32 is on or over the surface 34 of the protective coating layer 18; a surface 38 of the anti-banding layer 32 is opposite to the surface 36 of the anti-banding layer 32 and is a first outer surface of the transparency 10, and a surface 39 of the substrate 12 is opposite to the surface 26 of the substrate 12 and opposite to the surface 38 of the anti-banding coating layer 32 and is a second outer surface of the transparency 10.

In the broad practice of the invention, the substrate 12 can include any desired material having any desired characteristics. For example, the substrate 12 can be opaque, transparent or translucent to visible light. By “opaque” is meant having visible light transmission of 0%. By “transparent” is meant having visible light transmission in the range of greater than 0% to 100%. By “translucent” is meant allowing electromagnetic energy (e.g., visible light) to pass through but diffusing this energy such that objects on the side opposite the viewer are not clearly visible. Further, the substrate 12 can be but is not limited to conventional soda-lime-silicate glass, borosilicate glass, leaded glass or plastics, e.g. but not limited to the types used in the making of aircraft transparencies. In the preferred practice of the invention, but not limited thereto, the substrate 12 is glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process. Examples of float glass processes are disclosed in U.S. Pat. Nos. 4,744,809 and 6,094,942.

Although not limiting to the invention, examples of glass suitable for the substrate 12 are described in U.S. Pat. Nos. 4,746,347; 4,792,536; 5,030,593; 5,030,594; 5,240,886; 5,385,872; and 5,393,593. The substrate 12 can be of any desired dimensions, e.g., length, width, shape, or thickness. In one non-limiting embodiment of the invention, the substrate 12 can be 0.1 millimeter (‘mm”) to 12 mm thick, e.g., 1 mm to 5 mm thick (e.g., less than 3 mm thick), or 1.5 mm to 2.5 mm thick, or 1.8 mm to 2.3 mm thick, e.g., 2.1 mm thick.

The glass substrate 12 can have a high visible light transmission at a reference wavelength of 550 nanometers (“nm”) and a reference thickness of 2.1 mm. By “high visible light transmission” is meant visible light transmission at 550 nm in the range of greater than or equal to 85% to 92%, such as greater than or equal to 87% to 90%. Particularly useful glass for the practice of the invention is disclosed in U.S. Pat. Nos. 5,030,593 and 5,030,594 and is commercially available from PPG Industries, Inc. under the registered trademark Starphire.

The discussion is now directed to the functional coating 14. As used herein, the term “functional coating” refers to a coating that modifies one or more physical properties of the substrate over which it is deposited, e.g., optical, thermal, chemical or mechanical properties, and is not intended to be entirely removed from the substrate during subsequent processing. The coating 14 can have one or more functional coating layers or films of the same or different composition or functionality. The functional coating 14 is not limiting to the invention and can be any type of coating, applied on or over the surface 16 of the substrate 12 in any usual manner. More particularly, but not limiting to the invention, the functional coating 14 can be deposited by any conventional method, such as but not limited to conventional chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as but not limited to sol-gel deposition. In one non-limiting embodiment of the invention, the coating 14 can be deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750. In the preferred practice of the invention, the functional coating 14 is applied by magnetron sputter vacuum deposition (“MSVD”).

The invention is not limited to any particular type of functional coating and any of the functional coatings known in the art can be used in the practice of the invention. In the discussion of the invention, the coating is an electrically conductive coating 14 of the type disclosed in U.S. Pat. No. 7,335,421, however, the invention is not limited thereto and the functional coating 14 can be an electrically conductive coating, a heat treatable coating, a radiation reflecting metal or metal oxide coating. For example and not limiting to the invention, the functional coating 14 can be a solar control coating 14 of the type disclosed in U.S. Pat. No. 7,311,961, or an electrically conductive coating 14 of the type disclosed in U.S. Pat. Nos. 7,335,421 and 5,653,903 and 5,028,759, or a single-film or multi-film coating used as an antenna, or a reflective coating, e.g. but not limited to titanium oxide.

The functional coating 14 (hereinafter also referred to as “electrically conductive coating 14”) is deposited over at least a portion of the major surface 16 of the glass substrate 12. The electrically conductive coating 14 can include one or more metallic films positioned between pairs of dielectric layers applied sequentially over the glass substrate 12, and can have one or more coating layers or films of the same or different composition and/or functionality. As used herein, the term “film” refers to a coating region of a desired or selected coating composition. A “layer” can include one or more “films” and a “coating” or “coating stack” can include one or more “layers”. For example, the functional coating 14 can be a single layer coating or a multi-layer coating (as shown in FIG. 1) and can include one or more metals, non-metals, semi-metals, semiconductors, and/or alloys, compounds, compositions, or combinations thereof. For example, the functional coating 14 can be a single layer metal oxide coating, a multiple layer metal oxide coating, a non-metal oxide coating, a metallic nitride or oxynitride coating, a non-metallic nitride or oxynitride coating, or a multiple layer coating including one or more of any of the materials mentioned above. In one non-limiting embodiment, the functional coating 14 can be a doped metal oxide coating.

The functional coating 14 can be, for example, an electrically conductive coating used to make heatable windows as disclosed in U.S. Pat. Nos. 5,653,903 and 5,028,759, or a single-film or multi-film coating used as an antenna. Likewise, the functional coating 14 can be a conductive, solar control coating. As used herein, the term “solar control coating” refers to a coating including one or more layers or films that affect the solar properties of the coated article, such as but not limited to the amount of solar radiation, for example, visible, infrared, or ultraviolet radiation, reflected from, absorbed by, or passing through the coated article, shading coefficient, emissivity, etc. The solar control coating can block, absorb or filter selected portions of the solar spectrum, such as but not limited to the ultraviolet, visible and/or infrared spectrums. Examples of solar control coatings that can be used in the practice of the invention are found, for example but not to be considered as limiting, in U.S. Pat. Nos. 4,898,789; 5,821,001; 4,716,086; 4,610,771; 4,902,580; 4,716,086; 4,806,220; 4,898,790; 4,834,857; 4,948,677; 5,059,295; 5,028,759, and 6,495,251.

The functional coating 14 can also be an electroconductive low emissivity coating that allows visible wavelength energy to be transmitted through the coating but reflects longer wavelength solar infrared energy. By “low emissivity” is meant emissivity less than 0.4, such as less than 0.3, such as less than 0.2, such as less than 0.1, e.g., less than or equal to 0.05. Examples of low emissivity coatings are found, for example, in U.S. Pat. Nos. 4,952,423 and 4,504,109 and British reference GB 2,302,102.

Additional non-limiting examples of suitable functional coatings 14 for use with the invention are commercially available from PPG Industries, Inc. under the registered trademarks SUNGATE and SOLARBAN families of coatings. Such coatings typically include one or more antireflective coating films including dielectric or anti-reflective materials, such as metal oxides or oxides of metal alloys, which are transparent to visible light. The functional coating 14 can also include one or more infrared reflective films including a reflective metal, e.g., a noble metal such as gold, copper or silver, or combinations or alloys thereof, and can further include a primer film or barrier film, such as titanium, as is known in the art, located over and/or under the metal reflective layer. The functional coating 14 can have any desired number of infrared reflective films, such as, but not limited to 1 to 5 infrared reflective films. In one non-limiting embodiment, the coating 14 can have 1 or more silver layers, e.g., 2 or more silver layers, e.g., 3 or more silver layers, such as 5 or more silver layers. A non-limiting example of a suitable coating having three silver layers is disclosed in U.S. Patent Publication No. 2003/0180547 A1. As can now be appreciated, optionally a titanium film can be a functional film or a primer or barrier film.

FIG. 1 shows an exemplary non-limiting functional coating 14 suitable for the invention. This exemplary coating 14 includes a base layer or first dielectric layer 40 deposited over at least a portion of the major surface 16 of the glass substrate 12. The first dielectric layer 40 can include one or more films of antireflective materials anchor dielectric materials, such as but not limited to metal oxides, oxides of metal alloys, nitrides, oxynitrides, or mixtures thereof. The first dielectric layer 40 can be transparent to visible light. Examples of suitable metal oxides for the first dielectric layer 40 include oxides of titanium, hafnium, zirconium, niobium, zinc, bismuth, lead, indium, tin, and mixtures thereof. These metal oxides can have small amounts of other materials, such as manganese in bismuth oxide, tin in indium oxide, etc. Additionally, oxides of metal alloys or metal mixtures can be used, such as oxides containing zinc and tin (e.g., zinc stannate), oxides of indium-tin alloys, silicon nitrides, silicon aluminum nitrides, or aluminum nitrides. Further, doped metal oxides, such as antimony or indium doped tin oxides or nickel or boron doped silicon oxides, can be used. The first dielectric layer 40 can be a substantially single phase film, such as a metal alloy oxide film, e.g., zinc stannate, or can be a mixture of phases composed of zinc and tin oxides or can be composed of a plurality of metal oxide films, such as those disclosed in U.S. Pat. Nos. 5,821,001; 4,898,789; and 4,898,790.

In the illustrated exemplary embodiment shown in FIG. 1, the first dielectric layer 40 can include a multi-film structure having a first film 42, e.g., a metal alloy oxide film, deposited over at least a portion of the inner major surface 16 of the first ply 12 and a second film 44, e.g., a metal oxide or oxide mixture film, deposited over the first metal alloy oxide film 42. In one non-limiting embodiment, the first film 42 can be a zinc/tin alloy oxide. The zinc/tin alloy oxide can be that obtained from magnetron sputtering vacuum deposition from a cathode of zinc and tin that can include zinc and tin in proportions of 10 weight percent (“wt. %”) to 90 wt. % zinc, and 90 wt. % to 10 wt. % tin. One suitable metal alloy oxide that can be present in the first film 42 is zinc stannate. By “zinc stannate” is meant a composition of ZnxSn1−xO2−x (Formula 1) where “x” varies in the range of greater than 0 to less than 1. For instance, “x” can be greater than 0 and can be any fraction or decimal between greater than 0 to less than 1. For example where x=⅔, Formula 1 is Zn⅔Sn⅓O4/3, which is more commonly described as “Zn2SnO4”. A zinc stannate-containing film has one or more of the forms of Formula 1 in a predominant amount in the film. In one non-limiting embodiment, the first film 42 includes zinc stannate and has a thickness in the range of 100 Angstroms (“ANG”) to 500 ANG, such as 150 ANG to 400 ANG, e.g., 200 ANG to 300 ANG., e.g., 260 ANG.

The second film 44 can be a zinc-containing film, such as zinc oxide. The zinc oxide film can be deposited from a zinc cathode that includes other materials to improve the sputtering characteristics of the cathode. For example, the zinc cathode can include a small amount (e.g., less than 10 wt. %, such as greater than 0 to 5 wt. %) of tin to improve sputtering. In which case, the resultant zinc oxide film would include a small percentage of tin oxide, e.g., 0 to less than 10 wt. % tin oxide, e.g., 0 to 5 wt. % tin oxide. An oxide layer sputtered from a zinc/tin cathode having ninety-five percent zinc and five percent tin is written as Zn0.95Sn0.05O1.05 herein and is referred to as a zinc oxide film. The small amount of tin in the cathode (e.g., less than 10 wt. %) is believed to form a small amount of tin oxide in the predominantly zinc oxide-containing second film 44. The second film 44 can have a thickness in the range of 50 ANG to 200 ANG, such as 75 ANG to 150 ANG, e.g., 100 ANG. In one non-limiting embodiment in which the first film 42 is zinc stannate and the second film 44 is zinc oxide (Zn0.95Sn0.05O1.05), the first dielectric layer 40 can have a total thickness of less than or equal to 1,000 ANG, such as less than or equal to 500 ANG. e.g., 300 ANG to 450 ANG, e.g., 350 ANG to 425 ANG, e.g., 400 ANG.

A first heat and/or radiation reflective film or layer 46 can be deposited over the first dielectric layer 40. The first reflective layer 46 can include a reflective metal, such as but not limited to metallic gold, copper, silver, or mixtures, alloys, or combinations thereof. In one embodiment, the first reflective layer 46 includes a metallic silver layer having a thickness in the range of 25 ANG to 300 ANG, e.g., 50 ANG to 300 ANG, e.g., 50 ANG to 200 ANG, such as 70 ANG to 150 ANG, such as 100 ANG to 150 ANG, e.g., 130 ANG.

A first primer film 48 can be deposited over the first reflective layer 46. The first primer film 48 can be an oxygen-capturing material, such as titanium, that can be sacrificial during the deposition process to prevent degradation or oxidation of the first reflective layer 46 during the sputtering process or subsequent heating processes. The oxygen-capturing material can be chosen to oxidize before the material of the first reflective layer 46. If titanium is used as the first primer film 48, the titanium would preferentially oxidize to titanium dioxide before oxidation of the underlying silver layer. In one embodiment, the first primer film 48 is titanium having a thickness in the range of 5 ANG to 50 ANG, e.g., 10 ANG to 40 ANG, e.g., 15 ANG to 25 ANG, e.g., 20 ANG.

An optional second dielectric layer 50 can be deposited over the first reflective layer 46 (e.g., over the first primer film 48). The second dielectric layer 50 can comprise one or more metal oxide or metal alloy oxide-containing films, such as those described above with respect to the first dielectric layer. In the illustrated non-limiting embodiment, the second dielectric layer 50 includes a first metal oxide film 52, e.g., a zinc oxide (Zn0.95Sn0.05O1.05) film deposited over the first primer film 48. A second metal alloy oxide film 54, e.g., a zinc stannate (Zn2SnO4) film, can be deposited over the first zinc oxide (Zn0.95Sn0.05O1.05) film 52. A third metal oxide film 56, e.g., another zinc/tin oxide layer (Zn0.95Sn0.05O1.05), can be deposited over the zinc stannate layer to form a multi-film second dielectric layer 60. In one non-limiting embodiment, the zinc oxide (Zn0.95Sn0.05O1.05) films 52, 56 of the second dielectric layer 50 can each have a thickness in the range of about 50 ANG to 200 ANG, e.g., 75 ANG to 150 ANG, e.g., 100 ANG. The metal alloy oxide layer (zinc stannate) 54 can have a thickness in the range of 100 ANG to 800 ANG, e.g., 200 ANG to 700 ANG, e.g., 300 ANG to 600 ANG, e.g., 550 ANG to 600 ANG.

An optional second heat and/or radiation reflective layer 58 can be deposited over the second dielectric layer 50. The second reflective layer 58 can include any one or more of the reflective materials described above with respect to the first reflective layer 46. In one non-limiting embodiment, the second reflective layer 58 comprises silver having a thickness in the range of 25 ANG to 200 ANG, e.g., 50 ANG to 150 ANG, e.g., 80 ANG to 150 ANG, e.g., 100 ANG to 150 ANG, e.g., 130 ANG. In another non-limiting embodiment, this second reflective layer 68 can be thicker than the first and/or third reflective layers (the third reflective layer is discussed in detail below).

An optional second primer film 60 can be deposited over the second reflective layer 68. The second primer film 60 can be any of the materials described above with respect to the first primer film 48. In one non-limiting embodiment of the invention, the second primer film includes titanium having a thickness in the range of about 5 ANG to 50 ANG, e.g., 10 ANG to 25 ANG, e.g., 16 ANG to 25 ANG, e.g., 20 ANG.

An optional third dielectric layer 62 can be deposited over the second reflective layer 58 (e.g., over the second primer film 60). The third dielectric layer 62 can also include one or more metal oxide or metal alloy oxide-containing layers, such as discussed above with respect to the first and second dielectric layers 40, 50. In one non-limiting embodiment, the third dielectric layer 62 is a multi-film layer similar to the second dielectric layer 50. For example, the third dielectric layer 62 can include a first metal oxide layer 64, e.g., a zinc oxide (Zn0.95Sn0.05O1.05) layer, a second metal alloy oxide-containing layer 66, e.g., a zinc stannate layer (Zn2SnO4), deposited over the zinc oxide layer 64, and a third metal oxide layer 68, e.g., another zinc oxide (Zn0.95Sn0.05O1.05) layer, deposited over the zinc stannate layer 66. In one non-limiting embodiment, the zinc oxide layers 64, 68 can have thicknesses in the range of 50 ANG to 200 ANG, such as 75 ANG to 150 ANG, e.g., 100 ANG. The metal alloy oxide layer 66 can have a thickness in the range of 100 ANG to 800 ANG, e.g., 200 ANG to 700 ANG, e.g., 300 ANG to 600 ANG, e.g., 550 ANG to 600 ANG.

In one non-limiting aspect of the invention, the second dielectric layer 50 and third dielectric layer 62 have thicknesses that are within 10% of each other, such as within 5%, such as within 2% to 3% of each other.

The coating 14 can further include an optional third heat and/or radiation reflective layer 70 deposited over the third dielectric layer 62. The third reflective layer 70 can be of any of the materials discussed above with respect to the first and second reflective layers. In one non-limiting embodiment, the third reflective layer 70 includes silver and has a thickness in the range of 25 ANG to 300 ANG, e.g., 50 ANG to 300 ANG, e.g., 50 ANG to 200 ANG, such as 70 ANG to 150 ANG, such as 100 ANG to 150 ANG, e.g., 120 ANG. In one non-limiting embodiment, when the first, second, and/or third reflective layers have or contain silver, the total amount of silver for the coating 14 can range in the amount of 29 to 44 micrograms per centimeters2 (ugm/cm2), such as 36.5 ugm/cm2. In one non-limiting aspect of the invention, the first reflective layer 46 and third reflective layer 70 have thicknesses that are within 10% of each other, such as within 5%, such as within 2% to 3% of each other.

An optional third primer film 72 can be deposited over the third reflective layer 70. The third primer film 72 can be of any of the primer materials described above with respect to the first or second primer films. In one non-limiting embodiment, the third primer film is titanium and has a thickness in the range of 5 ANG to 50 ANG, e.g., 10 ANG to 25 ANG, e.g., 20 ANG.

An optional fourth dielectric layer 74 can be deposited over the third reflective layer (e.g., over the third primer film 72). The fourth dielectric layer 74 can include one or more metal oxide or metal alloy oxide-containing layers, such as those discussed above with respect to the first, second, or third dielectric layers 40, 50, 62. In one non-limiting embodiment, the fourth dielectric layer 74 is a multi-film layer having a first metal oxide layer 76, e.g., a zinc oxide (Zn0.95Sn0.05O1.05) layer, deposited over the third primer film 72, and a second metal alloy oxide layer 78, e.g., a zinc stannate layer (Zn2SnO4), deposited over the zinc oxide layer 76. The zinc oxide layer 76 can have a thickness in the range of 26 ANG to 200 ANG, such as 50 ANG to 150 ANG, such as 100 ANG. The zinc stannate layer 78 can have a thickness in the range of 25 ANG to 500 ANG., e.g., 50 ANG to 500 ANG, e.g., 100 ANG to 400 ANG, e.g., 200 ANG to 300 ANG, e.g., 260 ANG.

The functional coating 14 can contain additional groups of dielectric layer/reflective metal layer/primer layer units if desired. In one non-limiting embodiment, the coating 14 can contain up to five antireflective metal layers, e.g., up to five silver layers.

In the non-limiting embodiment of the invention under discussion, the protective overcoat 18 is deposited over the optional fourth dielectric layer 74 (if present) of the functional coating 14, to assist in protecting the underlying layers, such as the antireflective layers, from mechanical and chemical attack during processing. The protective coating 18 can be an oxygen barrier coating layer to prevent or reduce the passage of ambient oxygen into the underlying layers of the coating 14, such as during heating or bending. The protective coating 18 can be of any desired material or mixture of materials. In one exemplary embodiment, the protective coating 18 can include a layer having one or more metal oxide materials, such as but not limited to oxides of aluminum, silicon, or mixtures thereof. For example, the protective coating 18 can be a single coating layer including in the range of 0 wt. % to 100 wt. % alumina and/or 100 wt. % to 0 wt. % silica, such as 5 wt. % to 95 wt. % alumina and 95 wt. % to 5 wt. % silica, such as 10 wt. % to 90 wt. % alumina and 90 wt. % to 10 wt. % silica, such as 15 wt. % to 90 wt. % alumina and 85 wt. % to 10 wt. % silica, such as 50 wt. % to 75 wt. % alumina and 60 wt. % to 26 wt. % silica, such as 50 wt. % to 70 wt. % alumina and 50 wt. % to 30 wt. % silica, such as 36 wt. % to 100 wt. % alumina and 65 wt. % to 0 wt. % silica, e.g., 70 wt. % to 90 wt. % alumina and 30 wt. % to 10 wt. % silica, e.g., 75 wt. % to 85 wt. % alumina and 25 wt. % to 15 wt. % of silica, e.g., 88 wt. % alumina and 12 wt. % silica, e.g., 65 wt. % to 75 wt. % alumina and 35 wt. % to 25 wt. % silica, e.g., 70 wt. % alumina and 30 wt. % silica, e.g., 60 wt. % to less than 75 wt. % alumina and greater than 25 wt. % to 40 wt. % silica.

Other materials, such as oxides and/or nitrides of chromium, hafnium, yttrium, nickel, boron, phosphorous, titanium, zirconium can also be present, such as to adjust the refractive index of the protective coating 18. In one non-limiting embodiment of the invention, the protective coating 18 can have an index of refraction (i.e., refractive index) that is substantially the same as that of the substrate 12. For example, if the substrate 12 is glass having an index of refraction of 1.5, the protective coating 18 can have an index of refraction of less than 2, such as 1.3 to 1.8, e.g., 1.5.+/−.0.2. In another non-limiting embodiment of the invention, the refractive index of the protective coating 18 can be in the range of 1 to 3, such as 1 to 2, such as 1.4 to 2, such as 1.4 to 1.8.

In one non-limiting embodiment, the protective coating 18 is a combination of silica and alumina. The protective coating 18 can be sputtered from two cathodes (e.g., one silicon and one aluminum) or from a single cathode containing both silicon and aluminum. This silicon/aluminum oxide protective coating 80 can be written as SixAl1−xO1.5+x/2, where x can vary from greater than 0 to less than 1.

Alternatively, the protective coating 18 can be a multi-layer coating formed by separately formed layers of metal oxide materials, such as but not limited to a bilayer formed by one metal oxide-containing layer (e.g., a silica and/or alumina-containing first layer) formed over another metal oxide-containing layer (e.g., a silica and/or alumina-containing second layer). The individual layers of the multi-layer protective coating can be of any desired thickness.

Further, the protective coating 18 can be of any desired thickness. In one non-limiting embodiment, the protective coating 80 is a silicon/aluminum oxide coating (SixAl1−xO1.5+x/2) having a thickness in the range of 50 ANG to 50,000 ANG, such as 50 ANG to 10,000 ANG, such as 100 ANG to 1,000 ANG, e.g., 100 ANG to 500 ANG, such as 100 ANG to 400 ANG, such as 200 ANG to 300 ANG, such as 250 ANG. Although the usual practice is to provide a protective coating 18 having a uniform thickness, the invention can be practiced on a protective coating 18 having a non-uniform thickness. By “non-uniform thickness” is meant that the thickness of the protective coating 18 can vary across its length and/or width.

In another non-limiting embodiment, the protective coating 18 can include a first layer and a second layer formed over the first layer. In one specific non-limiting embodiment of the invention, the first layer can include alumina or a mixture or alloy including alumina and silica. For example and not limiting to the discussion, the first layer can include a silica/alumina mixture having greater than 5 wt. % alumina, such as greater than 10 wt. % alumina, such as greater than 15 wt. % alumina, such as greater than 30 wt. % alumina, such as greater than 40 wt. % alumina, such as 50 wt. % to 70 wt. % alumina, such as in the range of 70 wt. % to 100 wt. % alumina and 30 wt. % to 0 wt. % silica. In one non-limiting embodiment of the invention, the first layer can have a thickness in the range of greater than 0 ANG to 1 micron, such as 50 ANG to 100 ANG, such as 100 ANG to 250 ANG, such as 101 ANG to 250 ANG, such as 100 ANG to 150 ANG, such as greater than 100 ANG to 125 ANG. The second layer can include silica or a mixture or ahoy including silica and alumina. For example, the second layer can include a silica/alumina mixture having greater than 40 wt. % silica, such as greater than 50 wt. % silica, such as greater than 60 wt. % silica, such as greater than 70 wt. % silica, such as greater than 80 wt. % silica, such as in the range of 80 wt. % to 90 wt. % silica and 10 wt. % to 20 wt. % alumina, e.g., 85 wt. % silica and 15 wt. % alumina. In one non-limiting embodiment of the invention, the second layer can have a thickness in the range of greater than 0 ANG to 2 microns, such as 50 ANG to 5,000 ANG, such as 50 ANG to 2,000 ANG, such as 100 ANG to 1,000 ANG, such as 300 ANG to 500 ANG, such as 350 ANG to 400 ANG. Non-limiting examples of suitable protective coatings are described, for example, in U.S. Pat. Nos. 6,869,644; 6,916,542; 6,962,759, and 7,311,961, and U.S. Patent Publication Nos. 2002-0172775A1 and 2003-0228476.

Although the protective coating layer 18 protects the functional coating 14 and improves the emissivity of the functional coating 14, it has been observed that when the thickness of the silicon and aluminum protective layer 18 is within a certain thickness range, the color banding on the surface 34 of the protective layer is more noticeable when the coated surface of the protective layer 18 is viewed with the unaided eye, in an area illuminated by lights having spectrally narrow emissions such as fluorescent light and light emitting diodes. More particularly, the banding is noticeable when viewed with the unaided eye when the thickness of the silicon and aluminum protective layer 18 has a thickness in the range of 1 micron to less than 10 microns, however, color banding is also noticeable in the range of greater than 0.5 microns to 2 microns and 1-2 microns, when viewed with the unaided eye in an area illuminated by lights having spectrally narrow emissions such as fluorescent light and light emitting diodes. As used herein the term “the unaided eye” means that no optical enhancing equipment such as but not limited to polarized lenses and magnifying equipment is used other than equipment, e.g. clear, or uncolored eye glasses, to provide 20-20 eye vision.

The banding is particularly noticeable in an indoor area illuminated by lights having spectrally narrow emissions such as florescent lights and LEDs. The banding is also noticeable in the outdoors when the protective layer is illuminated by the sun and viewed by the unaided eye. However, the color banding of the protective coating is more noticeable in an indoor area lighted by lights having spectrally narrow emissions than an outdoor area because the Delta E of the coated article in the indoor lighted area is greater than 1. As is appreciated by those skilled in the art, for the majority of people the difference between two colors can be observed by the unaided eye when Delta E is greater than 1. For a better appreciation of the invention to reduce color banding observed on a surface of a silicon and aluminum protective coating over a functional coating, the following is presented.

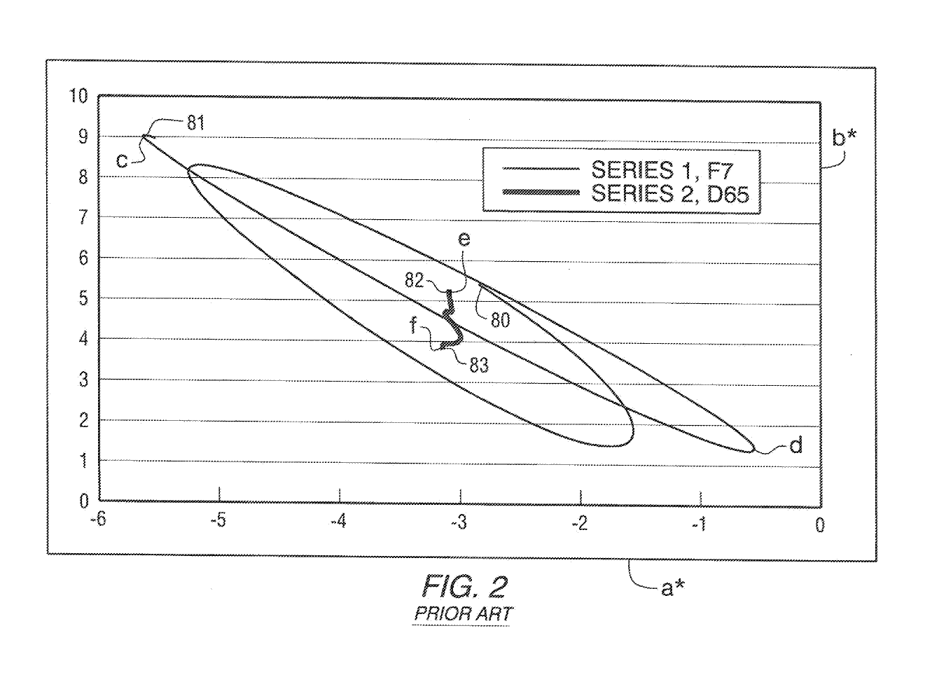

A computer generated sample coated article had a 60 nanometers thick titanium oxide functional film on the air side of a piece of 6 millimeter thick clear soda-lime silica float glass, and a 4 microns thick aluminum silicon oxide (15% alumina, 85% silica) protective film on the titania film. The air side of the float glass is the side of the glass opposite to the side floating on the molten metal bath. FIG. 2 shows a* and b* color co-ordinance (CIELAB color system) of the protective film of the coated article viewed under an F-7 florescent light (Series 1 curve) and viewed under a D-65 light source (Series 2 curve) at different lines of sight forming angles in the range of 20-40 degrees. For this discussion the “L*” component is along a sight line normal to the plane of FIG. 2 and for purposes of this discussion has minimal if any change in transmission with changes to the a* and the b*. Therefore in discussing the invention, “L*” is considered to be a constant. The curve of Series 1 at end 80 provides a*, b′ values of the color of the coated glass sample viewed at a line of sight that forms an angle of 20 degrees with a line normal to the glass surface, e.g. normal to the surface 34 of the protective coating 18. The curve of series 1 at end 81 provides a*, b* values of the color of the coated glass sample along a line of sight that forms an angle of 40 degrees with a line normal to the glass surface, e.g. normal to the surface 34 of the protective coating 18. The curve of Series 2 at end 82 provides a*, b* values of the color of the coated glass sample along a line of sight that forms an angle of 20 degrees with a line normal to the glass surface, e.g. normal to the surface 34 of the protective coating 18, and the curve of Series 2 at end 83 provides a*, b* values of the color of the coated glass sample along a line of sight that forms an angle of 40 degrees with a line normal to the glass surface, e.g. normal to the surface 34 of the protective coating 18. The portion of the Series 1 curve between the ends 80 and 81 and the portion of the Series 2 curve between the ends 82 to 83 are the a* b* values for the viewing angles from 200 to 400.

As can be appreciated by those skilled in the art, the difference between two colors or “Delta E” is determined by the following Equation using two colors in the CIELAB color system.

Delta E=the square root of((L*₂−L*₁)²+(a*₂−a*₁)²+(b*₂−b*₁)²) Equation:

Where: L*₁, a*₁, b*₁ is the designation of a first area of color, and

L*₂, a*₂, b*₂ is the designation of a second area of color.

In 1976 the definition of Delta E was extended to address perceptual non-uniformities, while retaining the L*, a*, b* color space, by the introduction of application-specific weights derived from an automotive paint test's tolerance data. For purposes of defining the invention, the Equation presented above is used without extending the definition of Delta E as adopted in 1976.

As noted above, for the majority of people the difference between two colors can be observed by the unaided eye when Delta E is greater than 1. The Delta E for points c and d for the Series 1 curve can be determined as follows. From the above discussion, L*_{c} is a constant k; and from FIG. 2 a*_{c} is −5.5, and b*_{c} is 9, and L_{d} is the constant k; a*d is −0.5, and b*_{d} is 1.5. Using the above Equation, the Delta E between color points a and b is equal to the square root of ((k−k)²+(−5.5 (−0.5))²+(9−1.5)²), which is equal to 8.96. Consider now the Delta E between points e and f of the Series 2 curve. From the above discussion, L*ₑ is a constant k; and from FIG. 2 a*ₑ is −3.0, and b* is 5.3, and L*_{f} is the constant k; a*f is −3.1, and b*_{f} is 3.9. Using the above Equation, the Delta E between color points e and f is equal to the square root of ((k−k)² (−3.0−(−3.1))² (4−5.3)²), which is equal to 1.3.

The above calculated Delta E's are not used for a direct comparison because the angle of sight for extreme points c and d of the Series 1 curve are not the same angle of sight for extreme points e and f of Series 2 curve. However, the calculated Delta E's do show the significant banding of the coating between the points when viewed under different lighting. More particularly, from the above discussion it can now be appreciated, that the Delta E of the color bands is increase when the coated article is viewed under lighting having spectrally narrow emissions, e.g. F-7 florescent light.

In one non-limiting embodiment of the invention, the anti banding coating 32 of the invention reduces the reflection of the underlying surface to reduce the Delta E between adjacent color bands on the underlying surface, e.g. the surface 34 of the protective layer 18 of the coated article 10 shown in FIG. 1 to a Delta E value of less than 5, more preferably less than 3 and most preferable less than 2 or less than 1 when viewed under lighting having spectrally narrow emissions, e.g. an F-7 florescent light at a sight angle within the range of 0° to 80°, and more preferably within the range of 20 to 40 degrees.

In one non-limiting embodiment of the invention, the anti banding coating 32 includes alternating layers of relatively high and low index of refraction materials. A “high” index of refraction material is any material having a higher index of refraction than that of the “low” index material. In one non-limiting embodiment, the low index of refraction material is a material having an index of refraction of equal to or less than 1.75, and the high index of refraction material is a material having an index of refraction of greater than 1.75. Although the dividing lines for these ranges is not a stark line and the index of refraction (hereinafter also referred to as “RI”) at the extremes of adjoining ranges can cross over between the adjacent regions to a degree.

Non-limiting examples of suitable materials for the high and low refractive index coating layers include various metal oxides, nitrides, and their alloys and mixtures thereof. For the higher refractive index, the materials include: zinc oxide (refractive index=1.90), titanium oxide (TiO2) (refractive index=2.3-2.7), CeO2 (refractive index=1.95), antimony oxide (Sb2O5) (refractive index=1.71), SnO2, ITO (refractive index=1.95), Y2O3 (refractive index=1.87), La2O3 (refractive index=1.95), zirconium oxide (ZrO2) (refractive index=2.05) and tin oxide, and indium oxide. Nonexclusive examples of the materials for the low index of refraction can include but are not limited to silicon dioxide, SiO2 (refractive index=1.45), Al2O3 (refractive index=1.65), B2O3 (refractive index=1.60), magnesium fluoride (refractive index 1.38), silicone polymer, and cryolite.

The anti-banding color coating 32 can be, for example, but not limiting to the present invention, a mull-layer coating as shown in FIG. 1 having a first metal alloy oxide layer or metal oxide layer 86 (first layer), a second metal alloy oxide layer or metal oxide layer 88 (second layer), a third metal alloy oxide layer or a metal oxide layer 90 (third layer), and a fourth metal alloy oxide layer or metal oxide layer 92 (fourth layer). In one non-limiting embodiment, the fourth layer 92 is an upper low index layer of silica or alumina or a mixture or combination thereof, the third layer 90 is an upper high index layer of zinc stannate or zirconia or mixtures or combinations thereof, the second layer 88 is a bottom low index layer of silica or alumina or a mixture or combination thereof, and the first layer 86 is a bottom high index layer of zinc stannate or zirconia or mixtures or combinations thereof. In this embodiment of the invention, the refractive index of the anti-banding color coating 32, which includes the layers 86, 88, 80 and 92 are combined to reduce the reflection of the protective layer 18 to reduce the Delta E difference between adjacent bands of anti-banding color coating 32.

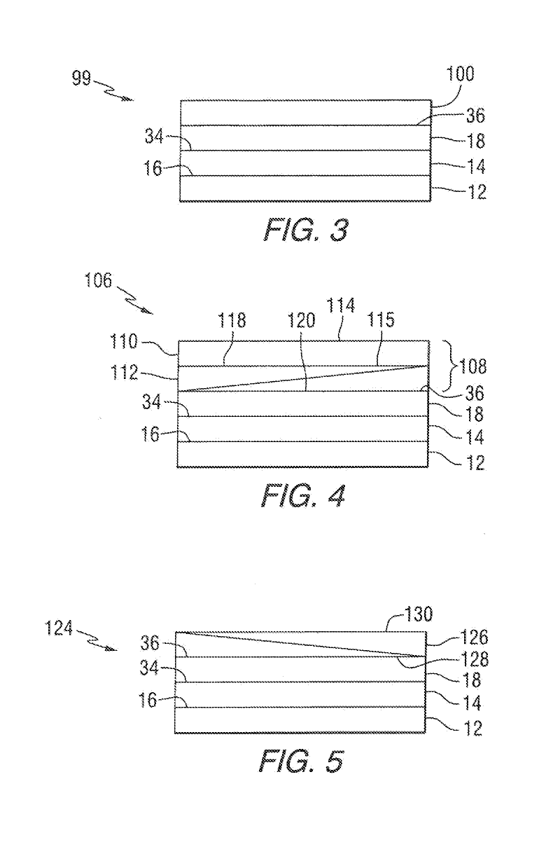

Shown in FIG. 3 is another coated transparency or coated article of the invention designated by the numeral 99. The coated article 99 includes the functional coating 14 over or on the surface 16 of the substrate 12; the protective layer 18 over or on the surface 34 of the functional layer 14, and an anti-banding coating layer 100 over or on the surface 36 of the protective layer 18. In the practice of the invention, providing an anti-banding coating that is equal to the square root of the index of refraction of |[DL1]|[DL2]|[DL3]|[DL4] the protective coating eliminates the banding viewed on the protective coating; in other words, the anti-banding coating has no banding when viewed under an F-7 florescent light.

In the embodiment of the invention shown in FIG. 3, the protective layer 18 is a single layer of mixed oxides of silicon and aluminum having an index of refraction of 1.54 and a thickness as measured between the surfaces of the protective layer 18 of 2 microns. The anti-banding coating layer 100 is a layer of magnesium fluoride having an index of refraction of 1.38, which is lower than the index of refraction of the protective layer 18, which in this embodiment of the invention is 1.54. The square root of 1.54 (the index of refraction of the protective layer 18) is 1.24. The index of refraction of the anti-banding coating 100 is 1.38. It is expected that the Delta E difference between adjacent banding of the anti-banding coating layer 100 will be less than 1.

Although it is expected that the anti-banding coating layer 100 of magnesium fluoride reduces the color banding of the protective layer 18, its use has limitations. More particularly, magnesium fluoride has very low mechanical and chemical durability and during the handling of the coated article, the magnesium fluoride coating 100 can be accidentally rubbed off causing optical distortion of the underlying coating.

Shown in FIG. 4 is another non-limited embodiment of a coated transparency or coated article of the invention designated by the numeral 106. The coated article 106 includes the functional coating 14 over the surface 16 of the substrate 12; the protective layer 18 over the surface 20 of the functional layer 14, and an anti-banding coating layer 108 of the invention over the surface 34 of the protective layer 18. The protective layer 18 is a single layer of mixed oxides of silicon and aluminum having a high index of refraction of 1.80 and a uniform thickness as measured between the surfaces of the protective layer 18 of 2 microns. The anti-banding coating layer 108 includes a homogenous layer 110 of a metal oxide over or on a graded layer 112 of two or more metal oxide layers. The term “homogenous layer” is defined as a layer that has a constant concentration of a metal oxide between opposed outer surfaces, e.g. surfaces 114 and 115 of the homogenous layer 110. The term “graded layer” as used herein is defined as a layer having two or more mixed metal oxides with the concentration of each metal oxide varying as the distance from one surface toward an opposite surface decreases.

By way of illustration and not limiting to the invention, the graded layer 112 of the anti-banding coating layer 108 has opposed surfaces 118 and 120, with the surface 120 of the graded layer 112 on or over of the surface 36 of the protective layer 18. The graded layer is a mixture of silicon oxide or silica (“SiO2”) and titanium oxide (“TiO2”). The surface 120 of the gradient layer 112 of the anti-bonding coating layer 108 has 99-100% SiO2 and 0%-1% TiO2. As the distance from the surface 120 increases the concentration of the SiO2 decreases and the concentration of the TiO2 increases. At the surface 118 of the graded layer 112 there is 99-100% TiO2 and 0%-1% SiO2. Further, the surface 120 of the layer 112 of the anti-banding color layer 108 has an index of refraction of 1.5, and the surface 118 of the layer 112 of the anti-banding color layer 108 has an index of refraction of 2.5. With continued reference to FIG. 4, the layer 110 of the anti-banding color layer 108 is a homogenous layer of silicon oxide having an index of refraction of 1.5.

Based on the forgoing, the protective layer 18 has a high RI, the layer 112 of the anti-banding color layer 108 has a low RI at the surface 120, and a high RI at the surface 115, and the layer 110 of the anti-banding color layer 108 has a low RI and a thickness of one quarter wavelength. With this arrangement it is expected that the Delta E between adjacent banding will be less than 2.

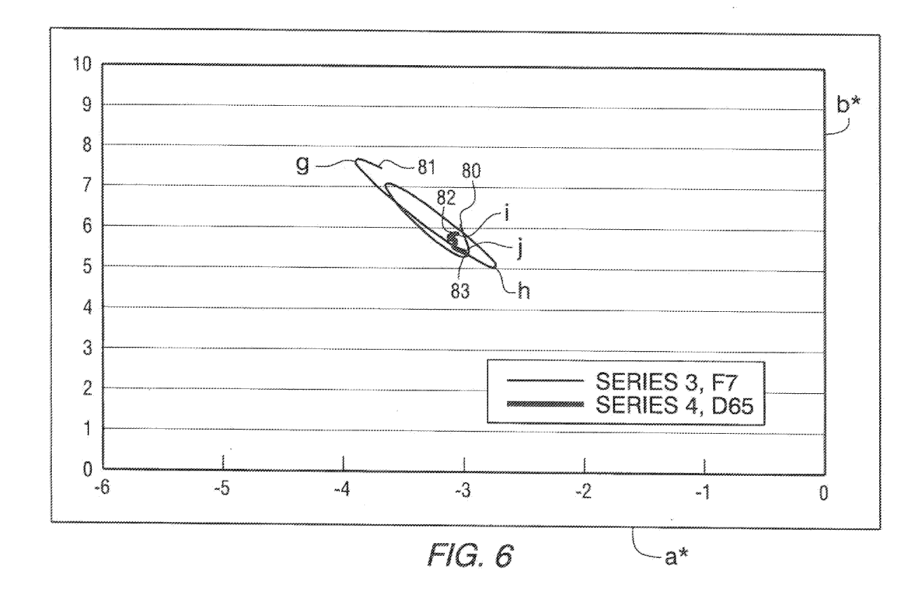

Shown in FIG. 5 is another non-limited embodiment of a coated transparency or coated article of the invention designated by the numeral 124. The coated article 124 includes the functional coating 14 over the surface 16 of the substrate 12; the protective layer 18 over the surface 20 of the functional layer 14, and an anti-blocking color layer 126 over the surface 34 of the protective layer. The protective color layer 18 at the surface 36 has a high index of refraction. The anti-banding color layer 126 is a metal oxide having a graded density to vary the porosity of the metal oxide to vary the index of refraction of the metal oxide layer. More particularly, the porosity of the metal oxide of the layer 126 changes as the distance from surface 128 in the direction of surface 130 of the layer 126 increases. In one embodiment of the invention, the protective layer 18 has a high index of refraction and the metal oxide of the layer 126 is SiO2. The SiO2 has a porosity of zero at the surface 128 and a porosity of 20% at the surface 130. The index of refraction of the layer 126 is 1.4 at the surface 128, and 1.75 at the surface 130. The invention is not limited to the manner in which the SiO2 is etched and any of the techniques known in the art e.g., but not limited to, the method disclosed in the Dynamic Etching of Silicon for Broadband Antireflection Applications, published in Applied Physics Letters, American Institute of Physics Volume 81, Number 16, dated 14 Oct. 2001 can be used.

A non-limiting embodiment of the invention is practiced on the sample coated article discussed above and having the color co-ordinance (CIELAB color system) shown in FIG. 2. A computer generated anti-banding (MSVD) coating layer of the invention is applied to the surface of the protective layer. The anti-banding coating layer, e.g. the coating layer 100 includes a first zinc stannate film having a thickness of 20.86 nanometers on the protective aluminum silicon oxide film, a first 85% alumina 15% silica film having a thickness of 27.74 nanometers on the first zinc stannate film; a second zinc stannate film having a thickness of 74.6 nanometers thick on the first 85% alumina 15% silica film, and a first 85% alumina 15% silica film having a thickness of 89.53 nanometers on the second zinc stannate film.

Shown in FIG. 6 are Series 3 and 4 curves. The Series 3 curve shows the coated article of the invention viewed under a fluorescent lighting F-7, and the Series 4 curve shows the coated article of the invention viewed under a D65 lighting. The Delta E for points g and h for the Series 3 curve can be determined as follows. From the above discussion, L*g is a constant k; and from FIG. 6 a*g is −4, and b*g is 7.6, and L h is the constant k; a*h is −2.8, and b*h is 5. Using the above Equation, the Delta E between color points a and b is equal to the square root of ((k−k)2+(−4−(−2.8))2+(7.686−5)2), which is equal to 2.86. Consider now the Delta E between points i and j of the Series 4 curve. From the above discussion, L*j is a constant k; and from FIG. 6 a*i is −3, and b*i is 6, and L*i is the constant k; a*j is −3, and b*j is 5.2. Using the above Equation, the Delta E between color points i and j is equal to the square root of ((k−k)2+(−3−(−3))2+(6−5.2)2), which is equal to 0.8.

As can now be appreciated, the practice of the invention (see Series 3 and 4 curves of FIG. 6) reduced the Delta E of the prior art coated sample from 8.96 (see Series 1 curve of FIG. 2) to 2.86 (see Series 3 curve of FIG. 6), and reduced the Delta E of the prior art coated sample from 1.3 (see Series 2 curve of FIG. 2) to 0.8 (see Series 4 curve of FIG. 6).

It will be readily appreciated by those skilled in the art that modifications can be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

1. (canceled)

2. In a coated article comprising:
a substrate having a major surface;
a functional coating over the major surface of the substrate, and
a chemical and/or mechanical protective coating on the functional coating, wherein the chemical and/or mechanical protective coating exhibits color banding when viewed under a light source having spectrally narrow emissions, and adjacent ones of the color banding of the chemical and/or mechanical protective coating have a first measured Delta E, the improvement comprising:
an anti-banding coating layer, wherein the anti-banding coating layer is on the chemical and/or mechanical protective coating, wherein the anti-banding coating layer exhibits color banding when viewed under the light source having spectrally narrow emissions, and adjacent ones of the color banding of the anti-banding coating layer have a second measured Delta E that is less than the first measured Delta E.

3. The coated article according to claim 2, wherein the light source having spectrally narrow emissions is selected from the group a florescent light and a light emitting diode.

4. The coated article according to claim 3, wherein the light source having spectrally narrow emissions is an F-2 florescent light.

5. The coated article according to claim 2, wherein the second measured Delta E is less than 3 determined using the following Equation:
Delta E=the square root of((L₂−L₁)²+(a*₂−a*₁)²+(b*₂−b*₁)²)
Where: L₁, a*₁, b*₁ is the designation of color for a first band, and
L₂, a*₂, b*₂ is the designation of color for a second band adjacent the first band.

6. The coated article of claim 2 wherein the functional coating comprises three metal films and four metal oxide films, wherein one of the metal films is between adjacent ones of the metal oxide films, and the protective coating comprises oxides and nitrides of silicon and aluminum, and combinations thereof.

7. The coated article according to claim 2 wherein the functional coating comprises a metal film between metal oxide or metal alloy oxide films, and the protective coating comprises oxides and nitrides of silicon and aluminum and combinations thereof.

8. The coated article according to claim 7, wherein the anti-banding coating comprises a first metal oxide layer or metal alloy oxide layer over the protective layer, a second metal oxide layer or metal alloy oxide layer over the first layer, a third metal oxide or metal alloy oxide layer over the second layer, and a fourth metal oxide layer or metal alloy oxide layer over the third layer.

9. The coated article according to claim 8 wherein the first metal oxide layer or metal alloy oxide layer has a high index of refraction; the second metal oxide layer or metal alloy oxide layer has a low index of refraction; the third metal oxide layer or metal alloy oxide layer has a high index of refraction, and the fourth metal oxide layer or metal alloy oxide layer has low index of refraction.

10. The coated article according to claim 9 wherein the first metal oxide layer or metal alloy oxide layer comprises zinc stannate or zirconia or mixtures or combinations thereof; the second metal oxide layer or metal alloy oxide layer comprises silica or alumina or a mixture or combination thereof; the third metal oxide layer or metal alloy oxide layer comprises zinc stannate or zirconia or mixtures or combinations thereof, and the fourth metal oxide layer or metal alloy oxide layer comprises silica or alumina or a mixture or combination thereof.

11. The coated article according to claim 2, wherein the protective layer is a single layer of mixed oxides of silicon and aluminum having an index of refraction of 1.54 and a uniform thickness as measured between opposed major surfaces of the protective layer up to 2 microns, and the anti-banding coating layer comprises a layer of magnesium fluoride having an index of refraction of 1.38, wherein a surface of the anti-banding coating layer farthest from the substrate is a first outer surface of the coated article and a surface of the substrate opposite to the major surface of the substrate is an opposite second outer surface of the coated article.

12. In a coated article comprising:
a substrate having a major surface;
a functional coating over the major surface of the substrate, and
a chemical and/or mechanical protective coating on the functional coating, wherein the chemical and/or mechanical protective coating exhibits color banding when viewed under a light source having spectrally narrow emissions, and adjacent ones of the color banding of the chemical and/or mechanical protective coating have a first measured Delta E, the improvement comprising:
an anti-banding coating layer on the chemical and/or mechanical protective coating, wherein the anti-banding coating layer exhibits color banding when viewed under the light source having spectrally narrow emissions, and adjacent ones of the color banding of the anti-banding coating layer have a second measured Delta E that is less than the first measured Delta E, wherein the anti-banding coating layer has an index of refraction, which is the square root of the index of refraction of the protective layer, wherein a surface of the anti-banding coating layer farthest from the substrate is a first outer surface of the coated article and a surface of the substrate opposite to the major surface of the substrate is an opposite second outer surface of the coated article.

13-21. (canceled)

22. The coated article according to claim 2 wherein a surface of the anti-banding coating layer farthest from the substrate is a first outer surface of the coated article and a surface of the substrate opposite to the major surface of the substrate is an opposite second outer surface of the coated article.
